(19) United States
(12) Patent Application Publication
(10) Pub. No.: US 2006/0079199 A1
(43) Pub. Date: Apr. 13, 2006

(54) Interrupting chip

(76) Inventor: Omar Thompson, Boston, MA (US)

Correspondence Address: LAMBERT & ASSOCIATES, P.L.L.C., 92 STATE STREET, BOSTON, MA, 02109-2004, US

(21) Appl. No.: 10/964,520

(22) Filed: Oct. 13, 2004

(51) Int. Cl. H04M 11/04; G08B 29/00

(52) U.S. Cl. 455/404.1; 455/404.2; 455/414.3

(57) ABSTRACT

Provided is an interrupting chip designed to eliminate the problems related to disseminating information via electronic devices when those devices are not powered on, or are not tuned to the appropriate channel capable of receiving emergency broadcast information. By providing an interrupting chip within electronic devices that convey information to people, the greatest number of the public would be notified of emergency information. The interrupting chip would allow for dissemination of important information quickly, efficiently, and at a low cost.

### BACKGROUND OF THE INVENTION

1. Field of the Invention

This invention relates generally to the field of electronic chips and more particularly to a specialized interrupting chip for alerting a user of a message.

2. Description of the Related Art

Society as a whole has become information hungry. The public's desire to receive news and information in real time is the driving force behind much of today's mass media outlets. Evidence of this can be found in television, radio, cell phones, computers pagers and myriad of other electronic devices. The greater the public's awareness of world events, the greater the desire for up to the minute news and information.

Competition to deliver content to individuals has become accordingly much more difficult. Individuals are required to sift through unwanted advertisements, desired programs, opinion pieces and various programs and messages. Often, messages are lost due to the oversaturation of a user. The result being that an individual may miss or not be aware of information that would normally be of interest to the user.

Computer websites often attempt to gauge interests of users by means of cookies and other tracking devices designed to track what content a user has previously viewed. Other forms of media take polls of targeted audiences in order to best tailor information in the most effective ways. When the message being conveyed is emergency information, transmitters of such information must take different approaches.

One factor to consider is who the transmitter of the message is. In emergency situations, the entity conveying the information will often be a governmental organization. One example can be found in the transmission of so called “Amber alerts.” While the Amber Alert system is now mandated across the country, states are still trying to discover how to best transmit the alerts to the public. Outdated Emergency Broadcast guidelines and different activation criteria in various states, highlight the need for additional work to make the system as efficient as possible. The system may utilize lighted highway signs, radio, television and internet broadcasts.

With respect to the internet, the public would only be aware of the alert if currently accessing the site, or if an emergency ticker is downloaded to the computer desktop. Radio and television emergency broadcasts are only effective if the devices are currently powered on. Additionally, there are channels that may be viewed and/or listened to that will not be interrupted by an alert sent by current emergency broadcasting methods.

The following are examples of prior art concerned with alerting individuals to some form of message:

Gropper, U.S. Pat. No. 5,781,852 discloses an alert receiver that is designed to receive alerts, record and timestamp the alerts so that the alert may be rebroadcast with the time it was received. The receiver also includes a means for automatically activating pagers upon receiving an alert, and for transmitting the nature of the alert to the pagers.

Pinder, U.S. Pat. No. 6,112,074 discloses a communication system that provides automatic notification to subscribers of the system of an event affecting a particular area. The information provided may be a weather alert, or other types of emergencies. The communication system may be a cellular system and may broadcast to a specific region only, or to subscribers designated as members of that particular region-group, regardless of where the subscribers are physically located at the time of dissemination.

Tarlton, et al., U.S. Pat. No. 6,462,665 discloses a method for sending a weather condition alert or other hazardous conditions. The method includes a broadcasting station, and a receiving unit. The receiving unit may include strobe lights and piezoelectric horns. The receiver may be programmed to activate automatically upon the occurrence of a specified condition.

Day, U.S. Pat. No. 6,463,273 discloses a wireless warning system for alerting users within a selected area of an emergency condition, when there is not the convenience, of a mass media source of information. The system may alert all users simultaneously via pager-type devices. In addition to emergencies, the system may be used for advisory purposes as well.

Lamb, U.S. Pat. No. 6,617,964 discloses a device and method for disseminating alerts to individuals via cellular, PCS or wireless telephone communications networks. The system includes a receiving unit with audio and visual alarms of varying intensity that can be mounted in a similar fashion as a smoke detector, or placed on a table or desk. The receiving unit may also coordinate with a plurality of peripheral units that are remote to the main receiving unit.

Cordina, U.S. Pat. No. 6,676,078 discloses a system for alerting personnel within the cockpit of an airplane of terrorist activity, or other dangerous conditions. Authorized personnel on board an aircraft would carry transmitters that may be used to signal a display unit located in the cockpit. The signal may also be transmitted to personnel on the ground as necessary.

Sweatt, U.S. Pat. No. 6,696,942 discloses an emergency warning network designed to rapidly disseminate information to specified people of impending dangers, including terrorist alerts and advisories. The information may be received by individuals in any location, and the information may be preceded by either an audio or visual alarm. The network includes a base station for broadcasting, where by the transmission is eventually received by portable receivers. The receiver may include audio alarms, or lights in colors such as white, green, blue, yellow, orange and red to convey an impression of the immediate likelihood of an act of terror as proposed by the Office of Homeland Security.

Skinner, U.S. Pat. No. 6,703,930 discloses a personal alerting apparatus that may be used almost anywhere in the world though the use of a communication device. The communication device may be internet-enabled, a cellular phone, a pager, a computer, etc. The apparatus may be used to alert the user of a variety of events, an event being any condition having predefined characteristics of which a sensor is configured to detect.

Each of the above mentioned devices performs their intended functions, yet none of them alleviate the problems inherent in devices that are unable to receive an alert or alert message by traditional means.

Therefore, what is needed is a means for interrupting a currently playing radio broadcast with an alert or alert message.

What is also needed is a device that will power on a radio if it is off, and select a subscribing channel for broadcasting an alert or alert message.

What is further needed is a means for interrupting a television program with an alert or alert message.

What is also required is a means for powering on a television that is off, and selecting a subscribing channel for broadcasting an alert or alert message.

It is also required to have a device that will be able to determine and set an appropriate volume level for a device where applicable.

Additionally, it is required that a user of a data storing device be prompted to save data and close open programs prior to receiving an alert or alert message.

It is also required that a device direct a user of a data storing device to a website or server that is capable of conveying an alert or alert message.

### BRIEF SUMMARY OF THE INVENTION

Accordingly, it is an object of the present invention to provide a means for powering on a device that may be off, and interrupting device that is already on, with the goal of providing a method for conveying an alert or alert message to the user.

It is a further object of the present invention to disseminate emergency information at any time to individuals operating or in the vicinity of a device capable of conveying an alert or alert message.

It is a further object of the present invention to provide an interrupting chip that includes a registration code that may be queried and used to identify the device, the location of the device, and to provide data necessary to making financial decisions with respect to funding an alert program.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 is a schematic illustrating various devices that may include the interrupting chip of the present invention.

FIG. 2 is a process flow diagram depicting the steps that may occur during activation of the interrupting chip in a preferred embodiment of the present invention.

FIG. 3 is an example of a typical warning prompting a user of a data storing device to save all data and close all programs.

FIG. 4 display one embodiment of a geographical location method using a plurality of antennae in communication with the interrupting chip of the present invention.

### DETAILED DESCRIPTION OF THE INVENTION

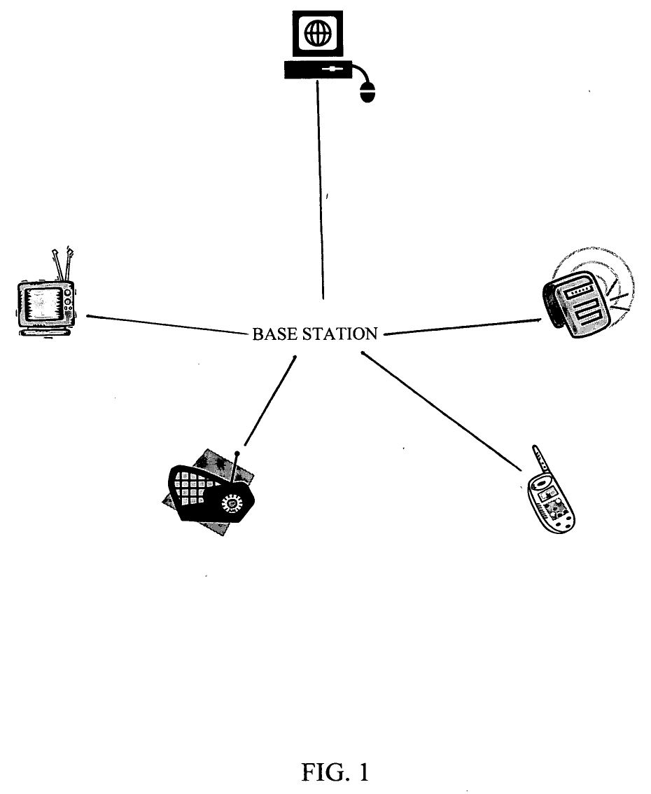

FIG. 1 illustrates a variety of devices that may include the interrupting chip. Any electronic device is a candidate for the interrupting chip. Preferred devices include televisions, radios, computers, cell phones, facsimile machines and pagers.

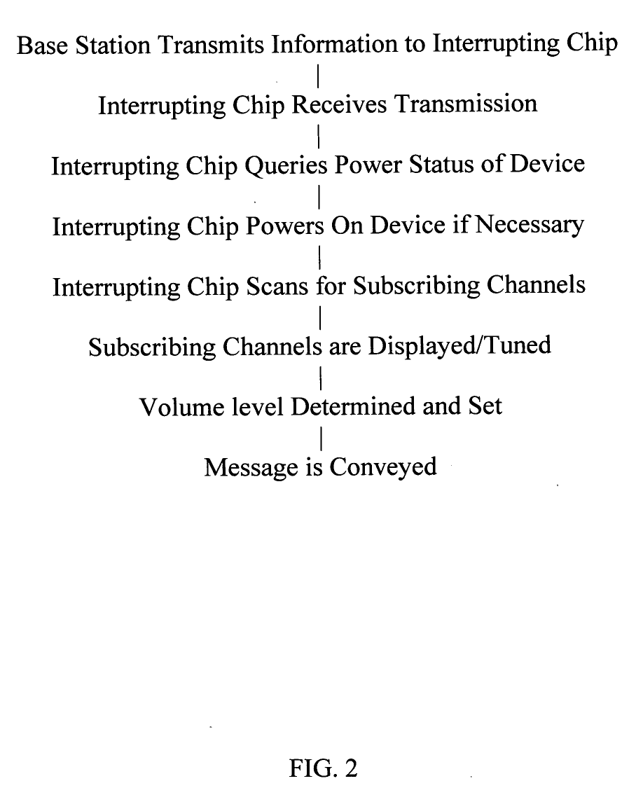

FIG. 2 illustrates a typical process for using the interrupting chip. A base station may be any location where information may be transmitted. Transmission means may include RF, satellite, or any other means known in the art. Transmissions may be picked up and carried by a variety of stations, or antennae, similar to a cellular phone network. The interrupting chip is preferably capable of receiving information and capable of transmitting information back to a receiving unit. The receiving unit may be part of the base station, or located separately. The information transmitted back to a receiving unit may include a unique registration code that identifies the interrupting chip.

Upon receiving a message from a base station that an alert or alert message is pending, the interrupting chip queries the device it is partnered with to determine if the device is currently powered on. If the device is not on, the chip will send instructions to the device to power it on. This can be achieved in a number of ways, one way would entail that a device that includes the chip never completely powers down, rather when a user performs powering down actions, the device is actually placed in a form of hibernation, or sleep-mode. This type of shut down status is easy to obtain, and is well known in the art.

Once the interrupting chip senses that the device is on, it scans to determine whether the device is currently tuned into a subscribing channel. The subscribing channel is one that has agreed to broadcast the alert or alert message. The interrupting chip will automatically tune the device to the subscribing channel and set the volume to an appropriate level and the alert is conveyed to the user. The alert may be simply a sound, a picture, color, symbols, pre-recorded message or live audio and/or live video presentations. For the television embodiment, the interrupting chip could also be programmed to determine if the television included what is known as “picture-in-picture” capability. If yes, multiple subscribing channels could be displayed and thereby allowing the user the ability to select a particular subscribing channel.

Funding for the system could be realized through the use of designated subscriber channels and interrupting chip registration codes. Channels could bid for the right to be a subscribing channel, plus taxes and increased prices for the devices could also be used for funding purposes. The increased cost of the devices would be minimized where a maximum number of devices include the interrupting chip.

In another embodiment, a timing mechanism could also be utilized that starts at a pre-set event, such as when the interrupting chip first receives information that an alert is pending, or when an alert begins to broadcast, and power the device down again upon expiration of the timer. Alternatively, the information sent to the interrupting chip could include information as to the message length, and this information could be used for the power down sequence.

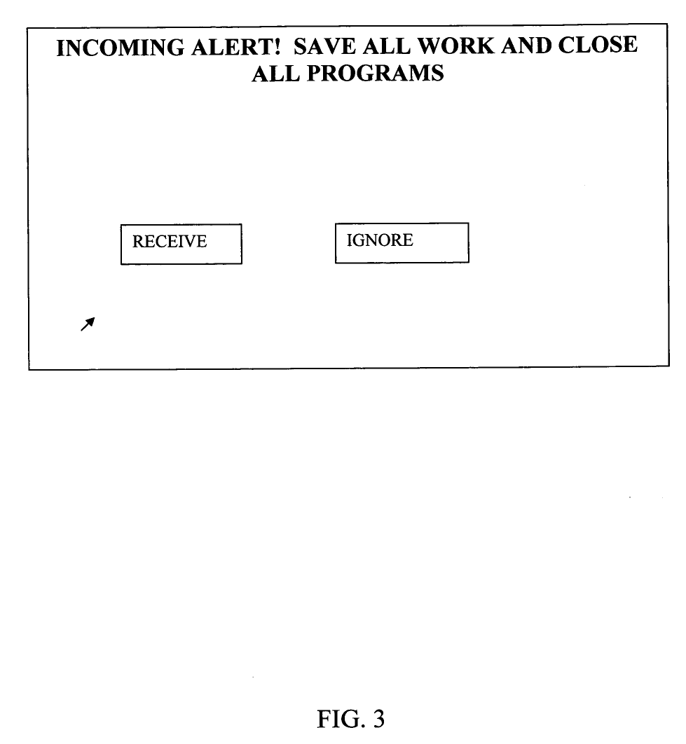

FIG. 3 displays a typical warning message alerting a user of a data storing device of an incoming alert. The data storing device may be personal computer, personal data assistant, pager or other similar device capable of storing information for some period of time. In the computer embodiment, the user has the option to save all work and close programs prior to receiving the alert. This safeguards the user against losing any data or current work products. Similar to the IGNORE button displayed in the user prompt, an ignore feature could be added to any of the other devices, including televisions, radios, and cell phones, that would allow the user to ignore the alert.

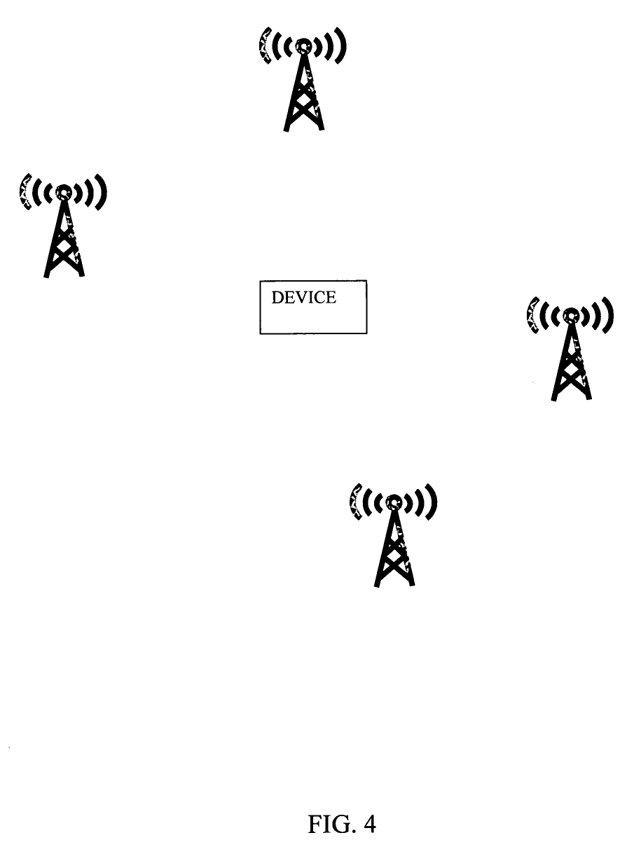

FIG. 4 displays a method for locating the geographical position of a device that includes the interrupting chip. Determining which transmitting antenna or antennae receives information back from the interrupting chip could be used to perform this function. Also, Global Positioning System (GPS) information could be included with the interrupting chip as is already known in the art and utilized in various devices such as cellular phones.

What is claimed is:

1. A method for alerting a user, said method comprising the steps of:
generating a first signal from a transmitter;
transmitting said first signal to an interrupt chip, wherein said interrupt chip is in communication with a device;
querying said device to determine whether said device is powered on or off;
powering on said device if said device is powered off; and
conveying an alert to a user.

2. The method of claim 1, wherein said interrupt chip includes a registration code.

3. The method of claim 2, wherein said interrupt chip is capable of transmitting identifying data.

4. The method of claim 3, wherein said identifying data includes said registration code.

5. The method of claim 4, wherein said identifying data further comprises geographical information.

6. The method of claim 5, wherein said step of conveying an alert to a user is followed by the steps of:
starting a timer;
powering off the device after expiration of a time period.

7. The method of claim 5, wherein said alert comprises an Amber alert.

8. The method of claim 5, wherein said alert comprises a weather alert.

9. The method of claim 5, wherein said alert comprises terrorist threat alert.

10. The method of claim 5, wherein said alert comprises information of national importance.

11. The method of claim 5, wherein said device is capable of receiving radio transmissions.

12. The method of claim 11, wherein prior to the step of conveying an alert to a user, further comprises the steps of:
searching for a subscribing channel;
tuning said device to said subscribing channel;
determining an appropriate volume level; and
setting said volume level.

13. The method of claim 12, wherein said radio transmissions are received by means of a satellite.

14. The method of claim 5, wherein said device comprises a means for storing data.

15. The method of claim 14, prior to the step of conveying an alert to a user, further comprising the step of asking a user to save any open programs and close any open windows.

16. The method of claim 15, further comprising the step of accessing a server.

17. The method of claim 15, further comprising the step of accessing a website.

18. The method of claim 17, further comprising the step of displaying said alert by means of said web site.

19. The method of claim 5, wherein said device is capable of receiving a television signal.

20. The method of claim 19, prior to the step of conveying an alert to a user, further comprising the steps of:
attempting to access a multiple screen display function searching for a subscribing channel;
displaying a subscribing channel in at least one multiple screen display;
selecting one of said multiple screen displays.
